(19) United States
(12) Patent Application Publication
(10) Pub. No.: US 2011/0207588 A1
(43) Pub. Date: Aug. 25, 2011

(54) EXERCISE DEVICE OF AN OSCILLATION TYPE

(76) Inventor: Jin-young Min, Wonju-si (KR)

(21) Appl. No.: 12/887,712

(22) Filed: Sep. 22, 2010

(30) Foreign Application Priority Data
Feb. 25, 2010 (KR) 10-2010-0017085
Feb. 25, 2010 (KR) 10-2010-0017089

(51) Int. Cl. A63B 26/00; H04R 11/02

(52) U.S. Cl. 482/142; 381/412

(57) ABSTRACT

An exercise device of an oscillation type is provided having upper and lower panels, and a magnet mounted on the lower plate for generating a magnetic field. A middle ring is coupled to a lower side of the magnet, an outer ring is formed along circumference of the lower plate, and an upper ring is mounted on a lower side of the outer ring. A bobbin is inserted into a magnetic gap formed between the upper ring and the middle ring. Voice coils are wound around the bobbin for oscillating the upper panel upward and downward while interacting with a magnetic field. A linear bushing bearing unit is mounted between the upper panel and the lower panel and a shaft is inserted therebetween for ensuring the bobbin moves in a vertical direction. A buffer spring is formed between the upper and lower panels for buffering oscillation of the upper panel.

### BACKGROUND OF THE INVENTION

1. Field of the Invention

The invention relates to a magnetic circuit of a single magnet structure, a sound wave actuator using this circuit and an exercise device of an oscillation type. More preferably, the object of the present invention is to oscillate the upper panel while the bobbin is moving upward and downward due to a magnetic field generated in a magnetic circuit unit and alternating power of a bobbin when arranging a magnetic circuit unit on a upper panel and further attaching a bobbin on a lower panel for generally transferring oscillations while maximizing a magnetic force generated in a magnetic gap between a upper ring and a middle ring by arranging a magnetic circuit unit using a single magnet, and by preventing magnetization generated from a magnet using a space between a magnet on a lower plate and an outer ring.

2. Description of the Related Art

Generally, an acoustic playing device is classified into a horn speaker, a woofer used in a hi-fi audio system such as a component system and covering a constant frequency bandwidth, a system speaker consisting of a midrange, a twitter and the like, a general speaker covering all frequency bandwidth by using one unit, a micro speaker of an ultra slim type having an ultra light weight which is used in the small electronic devices such as ultra tiny camcorder and a walkman, a receiver used in a terminal for a mobile communication, an earphone some parts of which are inserted into an ear, and a boozer for playing a frequency of a specific bandwidth.

In reviewing a conventional general speaker, a single magnet is arranged inside or outside a yoke, and a bobbin around which voice coils are wound is positioned in a magnetic gap of a magnetic circuit where a top plate is arranged on a upper side of a magnet. Further, the upper side of a bobbin has a structure wherein the circumferential part is fixed to a lower part and a upper part of a frame, a middle part is fixed to a oscillation plate where a hole of a circular shape is punched and a damper, a center cap (in other words, a dust cap) for closing a bobbin hole is coupled to a center of an oscillation plate.

In case of the above-mentioned speaker, since an oscillation plate and the voice coils oscillate upward and downward due to absorption and force of repulsion generated when non-alternating (direct) magnetic flux generated in a fixed magnetic circuit, and alternating rotation flux generated in the voice coils that can be move upward and downward are reacted mutually according to Fleming's left hand law, acoustic effect is generated corresponding to a driving signal.

In the conventional magnetic circuit using a single magnet where a magnetic gap is formed between a center pole and a top plate of a yoke, a size of an opposing yoke side for forming a magnetic gap is relatively limited to size and small, and uniform flux density is not formed on the opposing yoke side. That is, the opposing yoke side which is located relatively close to the magnet has higher flux density as compared with the opposing yoke side which is located relatively far to a magnet. As a result of it, according to the positions of the coils, absorption and force of repulsion affecting the voice coils inserted into a magnetic gap between the opposing yoke sides are not consistent.

When playing original sounds, this phenomenon influences upon upward and downward oscillation of a bobbin around which the voice coils are wound. Therefore, when playing the original sounds of an oscillation plate, there was a problem that distortion is generated.

Further, the above technology is suitable when a user feels vibrations in a three-dimensional way according to an audio signal, but sufficient magnetic force was not provided for driving an oscillation plate for an aerobics exercise.

Therefore, as illustrated in FIG. 1a and FIG. 1b of the Korean Patent No. 10-651766 indicated as the prior arts, “a magnetic circuit using a dual magnet, a speaker and an oscillation generation device using this” was disclosed.

The published technology has a structure wherein an outer magnet 11a and an inner magnet 11b are arranged in the first magnetic circuit MI and the second magnetic circuit M2, respectively; a flux leakage of a magnetic gap G is prevented due to the second magnetic circuit M2 of a loop type including the inner magnet 11b; a linear responsiveness of an oscillation system is improved by realizing uniform distribution of magnetic force lines on an opposite side of a yoke constituting a magnetic gap G of the first magnetic circuit M1 of a loop type including the outer magnet 11a and thereby a dual magnet having a frequency characteristics of high efficiency and low distortion is implemented. There are merits that a sound wave generator of the dual magnet structure can adjust an oscillation frequency and an acceleration very precisely like a speaker and it generates a force exceeding an amplitude of 2 cm and an acceleration of 3G. But, there is a demerit that the manufacturing processes are very complicated, more than 20 magnets having the diameter of 38 mm are required, and thus the cost of the materials is very expensive.

Further, miniaturization is necessary for expanding the application scope, but it was difficult to realize miniaturization since more than two magnets are employed and thereby massive size is a problem in the prior art.

Further, as the modern society is developing incessantly, the human beings begin to pay much attentions to the health and thus much interests are focused on losing weight. In addition, these days are flooded with various kinds of exercise machines and health supplementary foods to losing weight. But, modern men has no sufficient leisure time because of busy lifestyles and tight schedules. In case of most exercise machines which are widely known to us, the users have to move their own muscles when operating the exercise machines so that they can accomplish predetermined effects, but the effects are not obtained easily. Therefore, there are many cases that even if they have an obesity problem, they are indifferent to exercising.

In order to solve this problem, recently, people are interested in an oscillation exercise machine for enabling loosing weight effect to be obtained easily even when the users stand in the diverse postures on a vibrating foothold while tiny vibration is generated in a vertical direction, or a left and a right direction.

As the prior art of such an exercise machine, a foothold oscillation structure for bolstering up muscular strength (the Korean Patent Application No. 10-2004-84610) and an exercise device of an oscillation type (the Korean Patent Application No. 10-2004-87126) have been disclosed.

The foothold oscillation structure for bolstering up muscular strength consists of a boarding guide; a guide rod; a linear motor; a connection means; an elastic member; and a reinforcing elastic member. A foothold can move flexibly in a upward and a downward direction by inserting a guide rod into a pair of boarding guides arranged immovably on a bottom of a support frame. At the same time, a linear motor coupled to the foothold via a connection means which a vibration direction of a power is selected freely is installed on the bottom of the support frame. Due to a simple structure, reduction of the manufacturing cost and reduction of malfunction occurrence rate can be realized and fidelity of a product can be improved by executing the accurate operations.

The exercise device of an oscillation type consists of a vertical driving unit including a first yoke, a second yoke and a driving coil; a bobbin guide; a bobbin guide rod; a joint; a base; a guide; and an oscillation absorption means. Since a bobbin coil coupled to an oscillation plate is arranged on a magnetic circuit using a magnet which can generate a strong magnetic force and a magnetic gap, sufficient vertical exercise forces can be provided.

On the other hand, since the above-mentioned technology employs a sound wave generator of a dual magnet structure, it is possible to adjust precisely an amplitude frequency and an acceleration like a speaker, and it can generate a force exceeding an amplitude of 2 cm and an acceleration of 3G. But, there was a shortcoming that the manufacturing processes are very complicated and the cost of the used materials is very expensive.

### SUMMARY OF THE INVENTION

The present invention is devised in order to solve the above conventional problems and an object of the present invention is to abridge the manufacturing processes by simplifying a structure of a magnetic circuit unit using a single magnet, to reduce the manufacturing cost, and thereby to increase competitiveness.

Further, the lower plate, the middle ring, the outer ring and the upper ring constituting a magnetic circuit unit are magnetized by a magnet and another object of the present invention is to form the smoothly curved shapes by cutting the corners for reducing loss of magnetic forces.

Further, the middle ring of a magnetic circuit unit is magnetized by a magnet and another object of the present invention is to provide a middle ring wherein the corners thereof are formed as a square shape and the exterior portion of the middle ring is formed as a cylindrical shape for reducing loss of magnetic forces and maximizing the magnetic forces.

Further, another object of the present invention is to maximize a magnetic force generated in a magnetic gap between a upper ring and a middle ring by preventing magnetization generated from the magnet by forming a space between the magnet mounted on a lower plate and the outer ring.

Further, another object of the present invention is to provide an exercise device of a single magnet structure having special properties such as high output and high efficiency by increasing a flux density of a magnetic gap by a magnetic circuit including a single neodymium magnet, and suppressing generated a leakage flux from the magnetic gap.

Further, according to the present invention, in manufacturing a vertical exercise device using a magnetic circuit including a single magnet, a manufacturing process is simplified by designing a structure simply, and thus the manufacturing cost is reduced. As a result, the competitiveness of a product is enhanced and thereby, the consumers can buy the exercise machine easily at a cheap cost.

In this way, another object of the present invention is to enable the upper panel to move upward and downward by attaching a magnetic circuit unit including a single magnet to the upper panel of the exercise device moving upward and downward, and attaching a bobbin generally transferring oscillation while moving upward and downward to the lower panel tightly.

Further, another object of the present invention is to forcibly cool the heats of high temperature generated from a fan by arranging a fan on a lower part of a bobbin moving upward and downward.

The structure of the present invention accomplishing the above objects will be explained in detail as follows with referring to the attached drawings.

The present invention provides a magnetic circuit using a single magnet comprising a magnetic circuit unit consisting of a middle ring which is mounted on a middle projection unit of a lower plate of a circular shape and is coupled to a upper side of a magnet mounted for generating a magnetic field, an outer ring formed along circumference of the lower plate and a upper ring mounted on a upper side of the outer ring; a magnetic gap formed between the upper ring and the outer ring; and a bobbin which is inserted into the magnetic gap and around which voice coils to which alternating power is applied are wound for oscillating upward and downward while interacting with a magnetic field.

Further, The present invention provides a sound wave actuator using a single magnet comprising a magnetic mounted on a middle projection unit of a lower plate of a circular shape for generating a magnetic field; a middle ring coupled to a upper side of the magnet by a magnetic force; a upper ring mounted on a upper side of an outer ring formed along circumference of the lower plate; and a bobbin which is inserted into the magnetic gap formed between the upper ring and the middle ring and around which voice coils are wound for oscillating upward and downward.

Further, the present invention provides an exercise device of an oscillation type using a magnetic circuit of a single magnet structure comprising a magnetic circuit unit consisting of a magnet mounted on a lower center of the lower plate for generating a magnetic field, wherein a lower plate is coupled to a support board attached to a upper panel oscillating on a upper side, a middle ring coupled to a lower side of the magnet, an outer ring formed along circumference of the lower plate, and a upper ring mounted on a lower side of the outer ring; a bobbin which is inserted into the magnetic gap formed between the upper ring and the middle ring and around which voice coils are wound for oscillating the upper panel upward and downward while interacting with a magnetic field; a lower panel for fastening the bobbin safely and stably; a linear bushing bearing unit which is mounted between the upper panel and the lower panel, and into which a shaft is inserted for enabling the bobbin to move precisely in a vertical direction; and a buffer spring between the upper panel and the lower panel for buffering oscillation of the upper panel.

In the present invention of the above-mentioned structure, work efficiency can be improved by maintaining merits of a conventional sound wave generator including a dual magnet and at the same time, simplifying the manufacturing process as well as the manufacturing cost by reducing the number of the parts.

Further, according to the present invention, since a magnetic circuit unit consists of a lower plate, a middle ring, an outer ring and a upper ring which are coupled mutually by a single magnet, and magnetization generated from a magnet is prevented by a space formed between a magnet and an outer ring, a magnetic force generated in the magnetic gap between the upper ring and the middle ring can be maximized. Further, since the exercise device using a vertical movement uses upward and downward oscillation generated by a magnet and a voice coil, occurrence of a shock is reduced during operation, the noise occurrence is also reduced when using the exercise device, a shock applied to joints of a user is alleviated, and sufficient vertical movement force can be provided by driving the upper panel upward and downward while a bobbin moves upward and downward in a magnetic gap by interacting with a magnetic force generated in a magnetic circuit unit using a magnet.

Further, according to the present invention, it is possible to control the number of vertical movements precisely even in a low frequency bandwidth and thus a precise vertical movement is realized. Therefore, the present invention can provide an exercise device of an oscillation type wherein there are no serious damages on the human being's joints and noises and attrition of the parts are very small and trifling. The above and other aspects, features and advantages of the present invention will be more apparent from the following detailed description taken in conjunction with the accompanying drawings.

### BRIEF DESCRIPTION OF THE DRAWINGS

FIG. 1a is a front cross-sectional diagram of a magnetic circuit including a dual magnet.

FIG. 1b is a top cross-sectional diagram of a magnetic circuit including a dual magnet.

FIG. 2 is an analytical diagram illustrating an actuator using a single magnet of the present invention.

FIG. 3 is a diagram illustrating a cross-section of an actuator using a single magnet of the present invention.

FIG. 4 is an analytical diagram illustrating a vertical exercise device using a single magnet of the present invention.

FIG. 5 is a diagram illustrating assembly state of a vertical exercise device using a single magnet of the present invention.

FIG. 6 is a diagram illustrating an exercise device of the present invention.

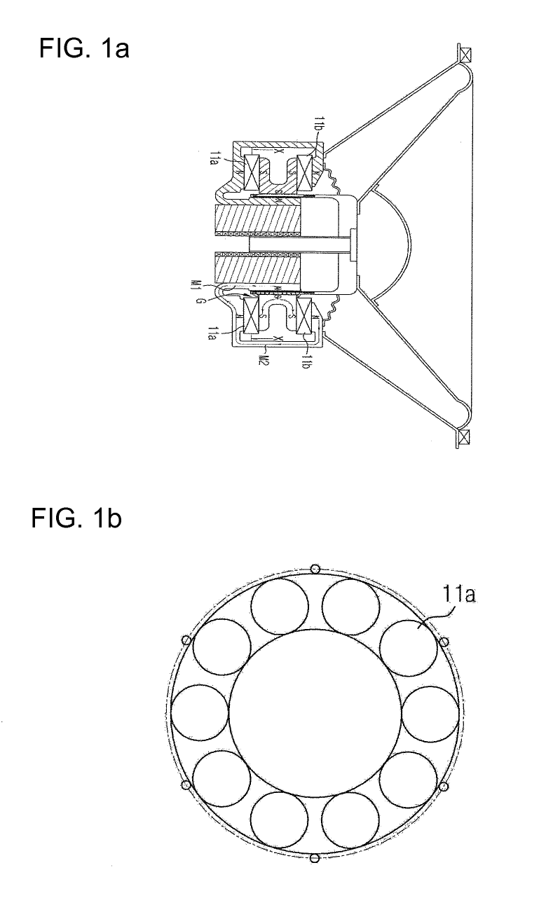

### DETAILED DESCRIPTION OF THE PREFERRED EMBODIMENTS

Below, the preferred embodiment according to the present invention will be explained with referring to the attached drawings.

The actuator 200 using a single magnet according to one preferred embodiment of to the present invention do not use a dual magnet which is widely known until now, but uses a single magnet 20 so that the manufacturing process of the actuator 200 can be simplified and miniaturization can also be realized.

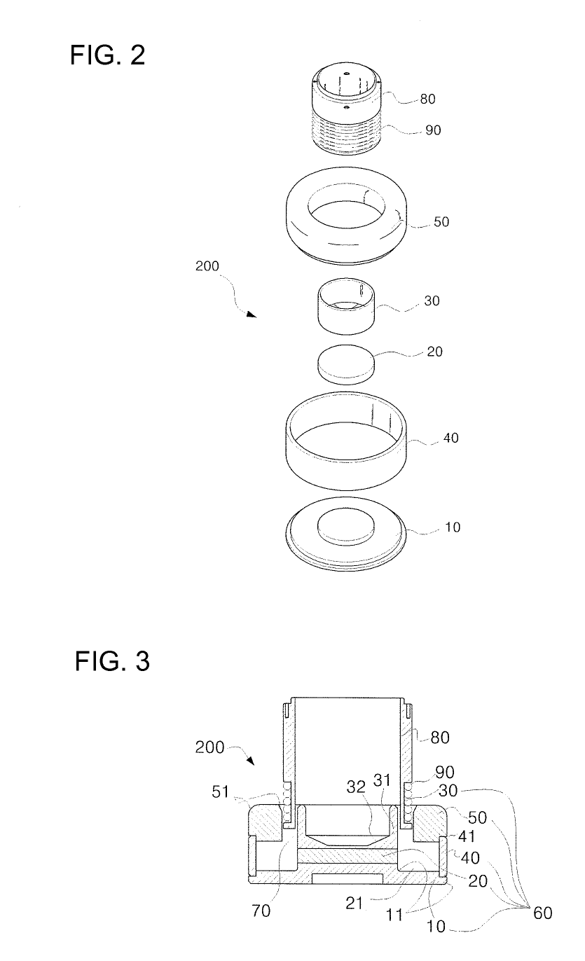

As illustrated in FIG. 2, according to the present invention, a single magnet 20 formed by neodymium is mounted on a projection unit protruding toward a center of a lower plate 10 of a circular shape. At this time, as the lower plate 10 is formed as a circular shape, it is preferable to form unit 60 are formed by the magnetic substances such as an iron (Fe) and thus, they are mutually coupled by the magnetic force generated from the magnet 20.

In addition, the bobbin 80 around which the voice coils 90 are wound on the circumference thereof is formed between the middle ring 30 and the upper ring 50 so that the magnetic gap 70 which can move upward and downward be formed.

Further, the bobbin moves upward and downward according to the Fleming's left hand law while the alternating current flowing through the voice coils 90 wound around the bobbin 80 is interacting with the magnetic force generated in the magnetic gap 70.

Further, the lower plate 10, the outer ring 40, and the upper ring 50 which are magnetized due to the magnetic force generated in the magnet 20 are formed as the smoothly curved shapes 11, 41, 51 by processing the corners thereof for reducing magnetism loss. The middle ring is also magnetized due to the magnetic force generated in the magnet 20 and the corner thereof is formed as a square shape 31 for reducing magnetism loss and maximizing magnetism to the outside, and exterior portion of the middle ring is formed as a cylindrical shape by processing the exterior portion in a tiled manner.

Further, since magnetization due to the magnet 20 is prevented by forming a space between the magnet 20 and the outer ring 40, the magnetic force generated in the magnetic gap 70 between the upper ring 50 and the middle ring 30 can be maximized.

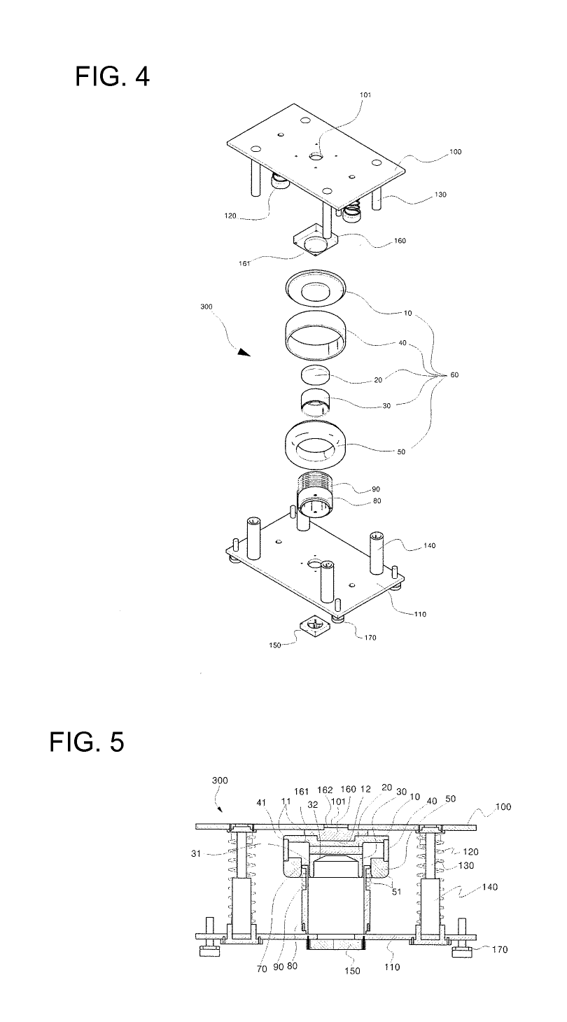

In addition, the exercise device 200 including a single magnet according to the present invention, and moving upward and downward does not use a dual magnet which is widely known in the prior art, and instead employs a single magnet 20. Therefore, the structure of the exercise device moving upward and downward can be simplified, and thereby the manufacturing processes are shortened and the device is miniaturized. As illustrated in FIG. 4, a single magnet 20 formed by neodymium is mounted in the lower center of the lower plate 10 of a circular shape.

The magnetic circuit unit 60 consists of the middle ring 30 coupled due to the magnetic force generated from the magnet 20 on mounted in the lower center of the lower plate 10 of a circular shape, and the upper ring 50 formed in the lower end of the outer ring 40 formed along the circumference of the lower plate 10.

At this time, if the outer ring 40 is inserted between the lower projection of the lower plate 10 and the upper projection of the upper ring 50 so that it can be coupled and fixed between the lower plate 10 and the upper ring 50, the outer ring 40 is coupled between the lower plate 10 and the upper ring 50 by the magnetic force of the magnet 20.

Further, the lower plate 10, the outer ring 40, and the upper ring 50 which are magnetized due to the magnetic force generated in the magnet 20 are formed as the smoothly curved shapes 11, 41, 51 by processing the corners thereof for reducing magnetism loss. The middle ring is also magnetized due to the magnetic force generated in the magnet 20 and the corner thereof is formed as a square shape 31 for reducing magnetism loss and maximizing magnetism to the outside, and exterior portion of the middle ring is formed as a cylindrical shape by processing the exterior portion in a tiled manner.

Further, since magnetization due to the magnet 20 is prevented by forming a space between the magnet 20 and the outer ring 40, the magnetic force generated in the magnetic gap 70 between the upper ring 50 and the middle ring 30 can be maximized.

Further, the magnetic field is formed in the magnetic gap 70 between the upper ring 50 and the middle ring 30 and if the alternating current is applied to the voice coils 90 wound along the circumference of the bobbin 80 inserted into the magnetic gap, the bobbin moves upward and downward in the magnetic gap 70 according to the Fleming's left hand law.

In this way, an insertion opening 12 is formed on the upper side of the lower plate 10 where the single magnet 20 is mounted, and the insertion opening 12 is supported by inserting a lower projection 161 of a support board 160 into the insertion opening 12. The upper projection 162 of the support board 160 is inserted into and then fixed to the insertion opening 101 of the upper panel 100 transferring oscillation to the upper direction.

Further, the lower plate 110 is mounted on the lower side of the bobbin 80 and a fixed board 170 is mounted on the corners of the lower plate 110 so that the bobbin can move upward and downward in the magnetic gap 70 according to the Fleming's left hand law, and transfer oscillation to the upper panel 100 in a stable way.

Further, two buffer springs 120 functioning as a buffer means are mounted between the upper panel 100 and the lower panel 110 for buffering vibrations of the upper panel 100 and the lower panel 110. In order to prevent the noises generated when the buffer springs 120 oscillate, the buffer springs 120 are fixed to a bracket 121 of synthetic resin materials mounted on the upper panel 100 and the lower panel 110.

A shaft 130 moving upward and downward is mounted at a corner of the upper panel 100 and a linear bushing bearing 140 into which the shaft 130 is inserted is mounted at a corner of the lower panel 110 so that the upper panel 100 can keep oscillating while moving upward and downward in the lower panel 110.

Further, if the present invention of a high output is used for a long time, much heats are generated in the bobbin 80. If the bobbin 80 is mounted on the upper panel 100, the heat is transferred to the upper panel 100 and thus it is not suitable for the users to do vibrating exercise because of the heat. In addition, an output is reduced and a life span of a magnet is also reduced due to a high heat of the magnet. Therefore, since the heat is transferred to the lower panel 110 due to heat conductivity if the bobbin 80 is mounted on the lower panel 110, the users can do exercise comfortably and securely on the upper panel 100.

Moreover, the inner magnet 20a (permanent magnet) is affected due to the high heat generated in the bobbin 80. That is, since magnetization of the magnet 20 is reduced at a high temperature, if the magnet 20 is exposed at a high temperature for a long time, a magnetic force is tremendously weakened and the output is reduced because of the weakened magnetic force. Thus, first of all, the bobbin 80 where the extremely much heat is generated is mounted on the lower panel 110 for cooling using a heat conductivity and secondly, a fan 150 is mounted for a forced cooling on the lower side of the bobbin 80.

Further, since a wire is fixed to the lower panel 110 for providing the alternating current to the voice coils 90 wound around the bobbin 80, damage of the wire can be prevented due to vibrations and coupling to a control unit can be simplified when assembling a system. The wire(not shown) is inserted into two through holes punched around the circumference of the bobbin 80 and is coupled to the voice coils 90.

Below, embodiments of the operations of an actuator using a magnetic circuit of the present invention will be explained in detail with referring to the drawings.

As illustrated in FIG. 2 and FIG. 3, according to the present invention, since a single magnet 20 formed by neodymium is used, the size of the magnet 20 is increased. The magnetic circuit unit 60 is formed when the lower plate 10, the middle ring 30, the outer ring 40, and the upper ring 50 are coupled mutually due to the magnetic field generated in the neodymium magnet of a divisional flat type wherein the constituting materials are directly magnetized, so that a magnetic field can be generated.

Therefore, since a space 21 between the magnet 20 mounted on a center projection of the lower plate 10 and the outer ring 40 mounted along the circumference of the lower plate 10 prevents magnetization generated from magnet 20, magnetization is maximized between the upper ring 50 and the middle ring 30. At the same time, as the maximized magnetization increases the flux density of the magnetic gap 70 formed between the middle ring 30 and the upper ring 50, the force applied to the voice coils 90 wound along the circumference of the bobbin 80 is increased. Besides it, as the allowed input is increased by rising the wiring amount of the voice coils 90 wound around the bobbin 80, a vibration system can vibrate sufficiently according to the input signal without limit.

In connection with the operations of an actuator 200 according to the present invention, since the middle ring 30, the outer ring 40 and the upper ring 50 which are formed by the iron materials are mutually coupled due to the magnetic field generated from the magnet 20 mounted on the lower plate 10 for forming a magnetic circuit unit 60, a magnetic field is formed in the magnetic gap 70 between the middle ring 30 and the upper ring 50. If the alternating current is applied to the voice coils 90 wound along the circumference of the bobbin 80 inserted into the magnetic gap 70, the bobbin 80 moves to upward and downward in the magnetic gap 70.

To be more specific, if the alternating current is applied to the voice coils 90 wound along the circumference of the bobbin 80 inserted into the magnetic gap 70 in the current direction (right direction), the bobbin 80 moves upward and downward in the magnetic gap 70 according to the Fleming's left hand law while the alternating current is interacting with the magnetic field created in the magnetic gap 70. If the alternating current applied to the voice coils 90 is applied to a direction opposite to the current direction, the bobbin 80 moves to the current vertical direction. Therefore, the bobbin 80 moves to the current vertical direction in the magnetic gap 70 and at the same time, transfers vibrations to an upper side.

Further, embodiments of the operations of an exercise device 200 of the present invention will be explained in detail with referring to the drawings.

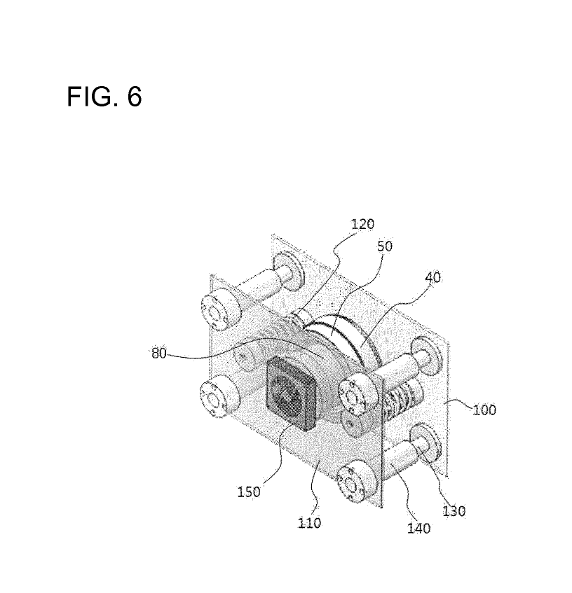

In connection with the operations of the exercise device of the present invention, as illustrated in FIG. 5 and FIG. 6, since the middle ring 30, the outer ring 40 and the upper ring 50 which are formed by the iron materials are mutually coupled due to the magnetic field generated from the magnet 20 mounted on the lower plate 10 for forming a magnetic circuit unit 60, a magnetic field is formed in the magnetic gap 70 between the middle ring 30 and the upper ring 50. If the alternating current is applied to the voice coils 90 wound along the circumference of the bobbin 80 inserted into the magnetic gap 70, the bobbin 80 moves to the current vertical direction in the magnetic gap 70 according to the Fleming's left hand law and at the same time, transfers vibrations to an upper side. Therefore, the users ride on the upper panel moving upward and downward and then enjoy exercising sufficiently.

Further, in the exercise device 200 of the present invention, four linear bushing bearings 140 moving upward and downward into which the shaft 130 is inserted between the upper panel 100 and the lower panel 110 are mounted Further, two buffer springs 120 functioning as a buffer means are mounted between the upper panel 100 and the lower panel 110 for buffering upward and downward vibrations. In addition, the heat generated by upward and downward vibrations of the bobbin 80 is transferred to the lower panel 110, and then is cooled. Since the remaining heat is forcibly cooled by the operations of the fan 150 attached on the lower side of the bobbin 80, the heat is not transferred to the upper panel 100. As a result, the users can enjoy the exercise on the upper panel 100 comfortably and safely.

Further, two buffer springs 120 functioning as a buffer means for the upper panel 100 vibrated upward and downward by the bobbin 80 are generally fixed to the upper panel and the lower panel by welding the springs to a flange. But, exposure generated by vibrations appears on account of the characteristics of the present invention. As a result, a welded portions is damaged due to accumulated fatigue, the noises are generated. In order to solve this problem, a bracket 121 is manufactured by a synthetic resin material having a suitable elastic intensity and the buffer springs 120 are attached to the bracket 121 so that the noises can be prevented and the damages to repetitious use can be also be prevented in advance.

The above description is only an illustrative explanation of the technological concepts of the present invention. It should be noted that various changes and modifications can be made without deviating from the inherent characteristics of the present invention by a person having a common knowledge in the technological field pertaining to the present invention.

Therefore, the embodiments of in the present invention are not described for limiting the technological concepts of the present invention, but described for explaining them. The scope of the technological concepts of the present invention is not limited by the foregoing embodiments.

Further, the protection scope of the present invention should be construed based on the scope of the following claims and all technological concepts within the equivalent scope must be construed as belonging to the scope of the patent rights of the present invention.

According to the present invention, a structure of an exercise device moving upward and downward by using a single magnet can be simplified and thereby miniaturization can be realized. In addition to the exercise device, a generator, a driving amplifier and the like using this device can be produced.

Further, according to the present invention, a magnetic field generated in the magnetic circuit unit formed by a single magnet enables a bobbin around which the voice coils are wound to move upward and downward, so that a upper panel can be vibrated. As a result of it, the present invention can be applied to diverse kinds of exercise machines such as a vertical exercise device moving upward and downward.

What is claimed is:

1. A magnetic circuit using a single magnet comprising,
a magnetic circuit unit consisting of a middle ring which is mounted on a middle projection unit of a lower plate of a circular shape and is coupled to a upper side of a magnet mounted for generating a magnetic field, an outer ring formed along circumference of the lower plate and a upper ring mounted on a upper side of the outer ring;
a magnetic gap formed between the upper ring and the outer ring; and
a bobbin which is inserted into the magnetic gap and around which voice coils to which alternating power is applied are wound for oscillating upward and downward while interacting with a magnetic field.

2. A sound wave actuator using a single magnet comprising,
a magnetic mounted on a middle projection unit of a lower plate of a circular shape for generating a magnetic field;
a middle ring coupled to a upper side of the magnet by a magnetic force;
a upper ring mounted on a upper side of an outer ring formed along circumference of the lower plate; and
a bobbin which is inserted into the magnetic gap formed between the upper ring and the middle ring and around which voice coils are wound for oscillating upward and downward.

3. The sound wave actuator using a single magnet according to claim 2, wherein magnetization generated from the magnet is prevented by forming a space between the magnet and the outer ring.

4. The sound wave actuator using a single magnet according to claim 2, wherein corners of the lower plate, the outer ring and the upper ring are formed as smoothly curved shapes by cutting the corners thereof for reducing magnetism loss, corners of the middle ring are formed as a square shape for reducing magnetism loss and maximizing magnetism to the outside, and exterior portion of the middle ring is formed as a cylindrical shape.

5. The sound wave actuator using a single magnet according any one of claim 2, wherein the lower plate, the middle ring, the outer ring and the upper ring consist of magnetic substances.

6. An exercise device of an oscillation type using a magnetic circuit of a single magnet structure comprising,
a magnetic circuit unit consisting of a magnet mounted on a lower center of the lower plate for generating a magnetic field, wherein a lower plate is coupled to a support board attached to a upper panel oscillating on a upper side, a middle ring coupled to a lower side of the magnet, an outer ring formed along circumference of the lower plate, and a upper ring mounted on a lower side of the outer ring;
a bobbin which is inserted into the magnetic gap formed between the upper ring and the middle ring and around which voice coils are wound for oscillating the upper panel upward and downward while interacting with a magnetic field;
a lower panel for fastening the bobbin safely and stably;
a linear bushing bearing unit which is mounted between the upper panel and the lower panel, and into which a shaft is inserted for enabling the bobbin to move precisely in a vertical direction; and a buffer spring between the upper panel and the lower panel for buffering oscillation of the upper panel.

7. The exercise device of an oscillation type using a magnetic circuit of a single magnet structure according to claim 6, wherein a fan is mounted on a lower side of the bobbin so that heats generated while the bobbin is oscillating upward and downward can be forcibly cooled.

8. The exercise device of an oscillation type using a magnetic circuit of a single magnet structure according to claim 6, wherein the buffer spring is attached to brackets which are formed by elastic materials consisting of a plastic or a rubber for reducing noises and are coupled to the upper panel and the lower panel.

9. The exercise device of an oscillation type using a magnetic circuit of a single magnet structure according to claim 6, wherein a projection unit protruding to a downward direction of the support board is inserted into an insertion groove formed on a upper side for supporting the lower plate, and the support board is formed by non-magnetic substances for preventing magnetization generated due to the magnetic circuit unit.

10. The exercise device of an oscillation type using a magnetic circuit of a single magnet structure according to claim 6, wherein the lower plate, the middle ring, the outer ring and the lower ring are formed by magnetic substances in which a magnetic force is generated.
